(19) United States
(12) Patent Application Publication
(10) Pub. No.: US 2023/0175301 A1
(43) Pub. Date: Jun. 8, 2023

(54) Vehicle and Control Method Thereof

(71) Applicants: Hyundai Motor Company, Seoul (KR); Kia Corporation, Seoul (KR)

(72) Inventor: Jaeman Song, (US)

(21) Appl. No.: 17/808,932

(22) Filed: Jun. 24, 2022

(30) Foreign Application Priority Data
Dec. 6, 2021 (KR) 10-2021-0172704

(51) Int. Cl. E05F 15/40; B60W 30/06; B60W 30/18; B60W 50/14

(52) U.S. Cl. CPC E05F 15/40; B60W 30/06; B60W 30/18036; B60W 50/14; E05Y 2400/54; E05Y 2900/546

(57) ABSTRACT

An embodiment vehicle includes a tailgate, a tailgate opening and closing device, a travelling device, an object detection sensor, and a controller configured to, in response to receiving an opening signal for the tailgate while the vehicle is parked, determine a distance to an obstacle located at a rear of the vehicle based on an output of the object detection sensor, and in response to the distance being greater than or equal to a predetermined dangerous distance, control the tailgate opening and closing device to open the tailgate, or in response to the distance being less than the predetermined dangerous distance, control the travelling device to move the vehicle by a predetermined movement distance in a reverse direction of a parking path and control the tailgate opening and closing device to open the tailgate after the vehicle moves by the predetermined movement distance.

### CROSS-REFERENCE TO RELATED APPLICATIONS

This application claims the benefit of Korean Patent Application No. 10-2021-0172704, filed on Dec. 6, 2021, which application is hereby incorporated herein by reference.

### TECHNICAL FIELD

The disclosure relates to a vehicle and a control method thereof.

### BACKGROUND

Recently, a power tailgate function capable of automatically opening and closing a tailgate has been installed in vehicles. Users may use the power tailgate function without needing to manually open and close the tailgate.

However, in a state where a driver is required to park close to a wall, or an obstacle is found after a driver exits the vehicle following parking, when the driver opens the tailgate before moving the vehicle, a collision is likely to occur, so the driver is unable to open the tailgate or is required to move the vehicle.

Also, a technology capable of autonomous driving and remote control parking has been being recently developed, and thus parking is possible through autonomous driving without user manipulation.

### SUMMARY

The disclosure relates to a vehicle and a control method thereof. Particular embodiments relate to a vehicle and a control method thereof that may automatically open and close a tailgate.

An embodiment of the disclosure provides a vehicle and a control method thereof that may identify a rear obstacle when a tailgate opening signal is input while parked, move the vehicle in a reverse direction of a parking path, and then open a tailgate, thereby securing a rear area of the vehicle when operating the tailgate.

Additional embodiments of the disclosure will be set forth in part in the description which follows and, in part, will be obvious from the description, or may be learned by practice of the disclosure.

According to an embodiment of the disclosure, there is provided a vehicle including a tailgate, an opening and closing device configured to open or close the tailgate, a travelling device configured to move the vehicle, an object detection sensor configured to detect an object around the vehicle, and a controller configured to, when receiving an opening signal for the tailgate while the vehicle is parked, determine a distance to an obstacle located at a rear of the vehicle based on an output of the object detection sensor, when the distance is greater than or equal to a predetermined dangerous distance, control the opening and closing device to open the tailgate, when the distance is less than the predetermined dangerous distance, control the travelling device so that the vehicle moves by a predetermined movement distance in a reverse direction of a parking path, and control the opening and closing device to open the tailgate after the vehicle moves by the predetermined movement distance.

The controller is configured to control the travelling device so that the vehicle returns to a location where the vehicle was parked, when receiving a closing signal for the tailgate after the tailgate is opened.

The vehicle further includes a user interface.

The controller is configured to control the user interface to output a message warning of a movement of the vehicle, when the distance is less than the predetermined dangerous distance.

The controller is configured to control the travelling device so that the vehicle starts moving in the reverse direction of the parking path, when a predetermined period of time elapses after the message warning of the movement of the vehicle is output, and control the vehicle not to move, when receiving a movement suspension command from a user before the predetermined period of time elapses after the message warning of the movement of the vehicle is output.

When identifying an obstacle located on a movement path while the vehicle moves in the reverse direction of the parking path, the controller is configured to control the travelling device so that the vehicle is stopped, and control the user interface to output a warning message informing that the vehicle is stopped.

The controller is configured to control the travelling device so that the vehicle resumes moving in the reverse direction of the parking path, when receiving a movement resumption command from a user after the vehicle is stopped.

The controller is configured to control the user interface to output a message warning of a movement of the vehicle, when receiving the closing signal for the tailgate after the tailgate is opened.

The controller is configured to control the travelling device so that the vehicle starts returning to the location where the vehicle was parked, when a predetermined period of time elapses after the message warning of the movement of the vehicle is output, and control the vehicle not to move, when receiving a movement suspension command from a user before the predetermined period of time elapses after the message warning of the movement of the vehicle is output.

When identifying an obstacle located on a movement path while the vehicle moves to return to the location where the vehicle was parked, the controller is configured to control the travelling device so that the vehicle is stopped, and control the user interface to output a warning message informing that the vehicle is stopped.

The controller is configured to control the travelling device so that the vehicle resumes moving to return to the location where the vehicle was parked, when receiving a movement resumption command from a user after the vehicle is stopped.

According to an embodiment of the disclosure, there is provided a control method of a vehicle including a tailgate, an opening and closing device configured to open or close the tailgate, a travelling device configured to move the vehicle, and an object detection sensor configured to detect an object around the vehicle, the control method including, when an opening signal for the tailgate is received while the vehicle is parked, determining a distance to an obstacle located at a rear of the vehicle based on an output of the object detection sensor, when the distance is greater than or equal to a predetermined dangerous distance, controlling the opening and closing device to open the tailgate, when the distance is less than the predetermined dangerous distance, controlling the travelling device so that the vehicle moves by a predetermined movement distance in a reverse direction of a parking path, and controlling the opening and closing device to open the tailgate after the vehicle moves by the predetermined movement distance.

The control method of the vehicle further includes controlling the travelling device so that the vehicle returns to a location where the vehicle was parked, when a closing signal for the tailgate is received after the tailgate is opened.

The vehicle further includes a user interface.

The controlling of the travelling device so that the vehicle moves by the predetermined movement distance in the reverse direction of the parking path includes controlling the user interface to output a message warning of a movement of the vehicle, when the distance is less than the predetermined dangerous distance.

The controlling of the travelling device so that the vehicle moves by the predetermined movement distance in the reverse direction of the parking path includes controlling the travelling device so that the vehicle starts moving in the reverse direction of the parking path, when a predetermined period of time elapses after the message warning of the movement of the vehicle is output, and controlling the vehicle not to move, when a movement suspension command is received from a user before the predetermined period of time elapses after the message warning of the movement of the vehicle is output.

When an obstacle located on a movement path is identified while the vehicle moves in the reverse direction of the parking path, the controlling of the travelling device so that the vehicle moves by the predetermined movement distance in the reverse direction of the parking path includes controlling the travelling device so that the vehicle is stopped, and controlling the user interface to output a warning message informing that the vehicle is stopped.

The controlling of the travelling device so that the vehicle moves by the predetermined movement distance in the reverse direction of the parking path includes controlling the travelling device so that the vehicle resumes moving in the reverse direction of the parking path, when a movement resumption command is received from a user after the vehicle is stopped.

The controlling of the travelling device so that the vehicle returns to the location where the vehicle was parked includes controlling the user interface to output a message warning of a movement of the vehicle, when the closing signal for the tailgate is received after the tailgate is opened.

The controlling of the travelling device so that the vehicle returns to the location where the vehicle was parked includes controlling the travelling device so that the vehicle starts returning to the location where the vehicle was parked, when a predetermined period of time elapses after the message warning of the movement of the vehicle is output, and controlling the vehicle not to move, when a movement suspension command is received from a user before the predetermined period of time elapses after the message warning of the movement of the vehicle is output.

### BRIEF DESCRIPTION OF THE DRAWINGS

These and/or other features of embodiments of the disclosure will become apparent and more readily appreciated from the following description of exemplary embodiments, taken in conjunction with the accompanying drawings, in which:

FIG. 1 is a control block diagram illustrating a vehicle according to an embodiment;

FIG. 2 is a diagram illustrating an example where a vehicle determines a distance to a rear obstacle when a tailgate opening signal is received while parked according to an embodiment;

FIG. 3 is a diagram illustrating an example where a vehicle determines that a distance to a rear obstacle is greater than or equal to a dangerous distance according to an embodiment;

FIG. 4 is a diagram illustrating an example where a vehicle determines that a distance to a rear obstacle is less than a dangerous distance according to an embodiment;

FIG. 5 is a diagram illustrating an example where an obstacle is located on a movement path of a vehicle according to an embodiment;

FIG. 6 is a diagram illustrating an example where a vehicle receives a tailgate closing signal and returns to a parked state according to an embodiment;

FIG. 7 is a diagram illustrating an example where an obstacle is located on a movement path of a vehicle according to an embodiment;

FIGS. 8A and 8B are flowcharts illustrating operations for securing a rear area when opening a tailgate in a control method of a vehicle according to an embodiment; and

FIGS. 9A and 9B are flowcharts illustrating operations for returning to a parking location after closing a tailgate in a control method of a vehicle according to an embodiment.

### DETAILED DESCRIPTION OF ILLUSTRATIVE EMBODIMENTS

Like reference numerals throughout the specification denote like elements. Also, this specification does not describe all the elements according to embodiments of the disclosure, and descriptions well-known in the art to which the disclosure pertains or overlapped portions are omitted.

It will be understood that when an element is referred to as being “connected” to another element, it can be directly or indirectly connected to the other element, wherein the indirect connection includes “connection” via a wireless communication network.

It will be understood that the term “include” when used in this specification, specifies the presence of stated features, integers, steps, operations, elements, and/or components, but does not preclude the presence or addition of one or more other features, integers, steps, operations, elements, components, and/or groups thereof.

It is to be understood that the singular forms are intended to include the plural forms as well, unless the context clearly dictates otherwise.

The terms such as “—part”, “—device”, “—block”, “—member”, “—module”, and the like may refer to a unit for processing at least one function or act. For example, the terms may refer to at least one process processed by at least one hardware, such as a field-programmable gate array (FPGA)/application specific integrated circuit (ASIC), software stored in memories or processors.

Reference numerals used for method steps are just used for convenience of explanation, but not to limit an order of the steps. Thus, unless the context clearly dictates otherwise, the written order may be practiced otherwise.

Hereinafter, a vehicle and a control method of a vehicle according to an embodiments of the disclosure will be described in detail with reference to the accompanying drawings.

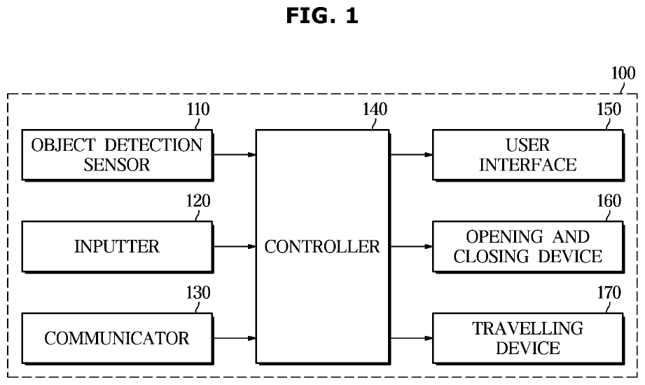

FIG. 1 is a control block diagram illustrating a vehicle according to an embodiment.

Referring to FIG. 1, a vehicle 100 according to an embodiment may include an object detection sensor 110, an inputter 120, a communicator 130, a controller 140, a user interface 150, an opening and closing device 160 and a travelling device 170. Here, the object detection sensor 110 may detect an object around the vehicle 100, the inputter 120 may receive a user input, and the communicator 130 may perform communication with a smart key (key fob) and a user terminal (smartphone). The controller 140 may control opening and closing of a tailgate, and travelling of the vehicle 100. The opening and closing device 160 may open and close the tailgate and the travelling device 170 may move the vehicle 100.

According to an embodiment, the object detection sensor 110 may detect an object around the vehicle 100, and be provided as at least one of an ultrasonic sensor, a radar sensor, an image sensor, and a light detection and ranging (lidar) sensor.

According to an embodiment, the inputter 120 may receive a command for opening and closing the tailgate from a user. For example, the inputter 120 may include a button provided on a driver's seat side of the vehicle 100, a button provided on the tailgate, and the like.

According to an embodiment, the communicator 130 may communicate with a smart key or a user terminal through wireless communication, and receive a tailgate opening signal or a tailgate closing signal from the smart key or the user terminal. To this end, the communicator 130 may be provided as a known type of wireless communication module.

According to an embodiment, when receiving the tailgate opening signal while the vehicle wo is parked, the controller 140 may determine a distance to a rear obstacle based on an output of the object detection sensor no, and when the distance to the rear obstacle is greater than or equal to a dangerous distance, control the opening and closing device 160 to open the tailgate.

When the distance to the rear obstacle is less than the dangerous distance, however, the controller 140 may first control the travelling device 170 so that the vehicle 100 moves by a predetermined movement distance in a reverse direction of a parking path before opening the tailgate, and when the movement is completed, may open the tailgate. Accordingly, the tailgate may be prevented from colliding with the rear obstacle.

Afterwards, when the tailgate closing signal is received, the controller 140 may control the opening and closing device 160 to close the tailgate, and also control the travelling device 170 so that the vehicle 100 returns to a location where the vehicle 100 was parked.

In addition, the controller 140 may control the user interface 150 to output a warning message before moving the vehicle 100, and also control the user interface 150 to output a warning message when an obstacle is identified on a movement path where the vehicle wo moves.

In this instance, when a movement suspension command is received from the user in response to the warning message, the controller 140 may control the vehicle wo not to move. When a movement resumption command is received from the user in response to the warning message, the controller 140 may control the vehicle 100 to move.

The controller 140 may include at least one memory storing a program for performing the aforementioned operations and operations described below, and at least one processor for implementing a stored program. When a plurality of memories and processors are provided, the plurality of memories and processors may be integrated into one chip, or may be provided in physically separated locations.

For example, the controller 140 may include an advanced driver assistance system (ADAS), a parking electronic control unit (ECU), an integrated central control unit (ICU), a parking distance warning (PDW), a forward collision avoidance assist (FCA), a blind spot collision avoidance assist (BCA), a rear collision avoidance assist (RCA), and the like.

According to an embodiment, the user interface 150 may receive an input from the user or output various data. The user interface 150 may include an inputter capable of receiving an input from the user, and a display and/or a speaker capable of outputting various data. In this instance, according to embodiments, the inputter of the user interface 150 may be provided as a touch panel provided integrally with the display, but is not limited thereto. A type of the inputter of the user interface 150 is not limited.

According to an embodiment, the user interface 150 may receive a user input regarding whether to activate a function of the controller 140 that automatically moves the vehicle 100 according to the tailgate opening signal and the tailgate closing signal.

Also, according to an embodiment, when the vehicle 100 moves automatically or the obstacle exists on the movement path of the vehicle 100, the user interface 150 may output the warning message under control of the controller 140.

According to an embodiment, the opening and closing device 160 may open and close the tailgate and include an actuator for automatically opening and closing the tailgate. One end of the actuator is mounted on a vehicle body and the other end is mounted on the tailgate to apply moving force to the tailgate. To this end, the actuator may include a motor and a power member.

According to an embodiment, the travelling device 170 may move the vehicle 100 and include a steering device, a driving device and a brake device.

The constituent components of the vehicle 100 have been described above. Hereinafter, the vehicle 100 securing a rear area to open the tailgate is described in detail.

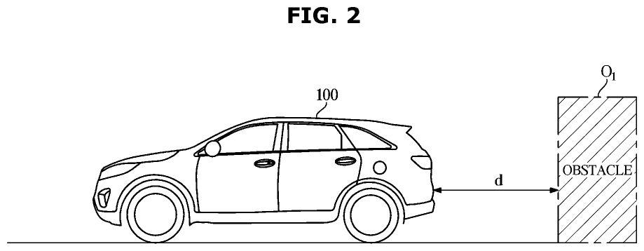

FIG. 2 is a diagram illustrating an example where the vehicle 100 determines that a distance to a rear obstacle when a tailgate opening signal is received while parked according to an embodiment.

Referring to FIG. 2, according to an embodiment, the vehicle 100 may determine a distance d to a rear obstacle O₁, when a tailgate opening signal is received while parked.

That is, when the tailgate opening signal is received while parked, the vehicle 100 may determine the distance d to the rear obstacle O₁ based on an output of the object detection sensor 110.

In this instance, the tailgate opening signal may be received from a smart key or a smartphone through the communicator 130, or through the inputter 120. Also, the controller 140 may generate a tailgate opening signal using a smart tailgate function, when a user with a smart key is located around the tailgate for a predetermined period of time.

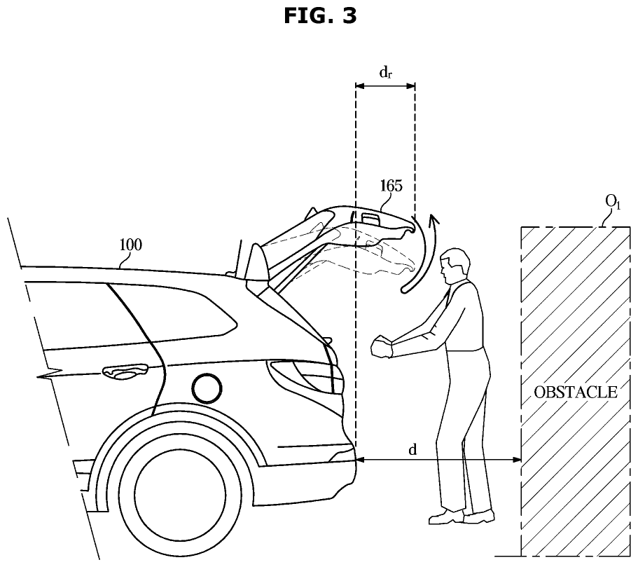

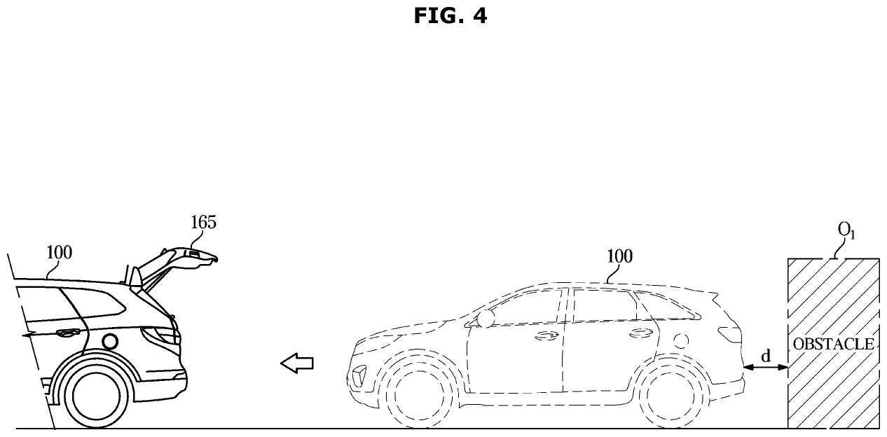

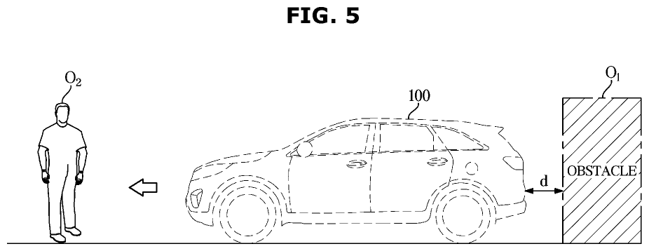

FIG. 3 is a diagram illustrating an example where the vehicle 100 determines that a distance to a rear obstacle O₁ is greater than or equal to a dangerous distance according to an embodiment. FIG. 4 is a diagram illustrating an example where the vehicle 100 determines a distance to the rear obstacle O₁ is less than a dangerous distance according to an embodiment. FIG. 5 is a diagram illustrating an example where an obstacle is located on a movement path of the vehicle wo according to an embodiment.

Referring to FIG. 3, according to an embodiment, when it is determined that a distance d to the rear obstacle O₁ is greater than or equal to a dangerous distance dᵣ, the vehicle wo may control the opening and closing device 160 to open a tailgate 165.

In this instance, the dangerous distance dᵣ is a distance indicating a rear area required for the tailgate 165 to be opened. For example, the dangerous distance dᵣ may be determined as a value greater than or equal to a distance between a rear end of the vehicle 100 and an end of the tailgate 165 when the tailgate 165 is fully opened.

That is, when the distance d to the rear obstacle O₁ is greater than or equal to the dangerous distance dᵣ, and so no risk of collision between the tailgate 165 and the rear obstacle 01 is determined, the vehicle wo may control the opening and closing device 160 to immediately open the tailgate 165 in a state where the vehicle wo is parked.

Referring to FIG. 4, according to an embodiment, when it is determined that the distance d to the rear obstacle O₁ is less than the dangerous distance dᵣ, the vehicle wo may control the travelling device 170 so that the vehicle 100 moves by a predetermined movement distance (e.g., 2 m) in a reverse direction of a parking path, and after the vehicle 100 moves by the predetermined movement distance, control the opening and closing device 160 to open the tailgate 165. In this instance, the reverse direction of the parking path may be a direction opposite to a direction where the vehicle wo enters a parking location, and correspond to a direction where the vehicle wo exits the parking location.

In this instance, according to embodiments, the predetermined movement distance may be set to a value longer than a length of the tailgate 165, for example, a value 0.4 m longer than the length of the tailgate 165. Accordingly, after the vehicle wo moves by the predetermined movement distance, a user may load or unload luggage in a state where a free space is secured.

According to embodiments, however, the vehicle 100 may adaptively adjust the movement distance. Specifically, the vehicle wo may set a maximum value of the movement distance as a distance required for opening and closing the tailgate 165, and adaptively adjust the movement distance based on a distance between the rear obstacle O₁ and the vehicle 100. That is, the vehicle 100 may calculate a movement distance required to secure a space for opening and closing the tailgate 165, based on the distance between the rear obstacle O₁ and the vehicle 100.

Also, according to embodiments, as shown in FIG. 4, when it is determined that the distance d to the rear obstacle O₁ is less than the dangerous distance dᵣ, the vehicle wo may control the user interface 150 to output a message warning of a movement of the vehicle 100 (e.g., The vehicle will move in a direction right before parking to secure a space for opening a tailgate. If undesired, press a switch to stop an operation.)

In this instance, when a predetermined period of time (e.g., 3 seconds) elapses after the message warning of the movement of the vehicle 100 is output, the vehicle 100 may control the travelling device 170 so that the vehicle 100 starts moving in the reverse direction of the parking path.

In addition, when receiving a movement suspension command from the user before the predetermined period of time (e.g., 3 seconds) elapses after the message warning of the movement of the vehicle 100 is output, the vehicle 100 may be controlled not to move. In this instance, the movement suspension command may be received from a smart key or a user terminal through the communicator 130, or through the inputter 120 or the user interface 150.

Referring to FIG. 5, according to an embodiment, when identifying an obstacle O₂ located on a movement path while moving in the reverse direction of the parking path, the vehicle 100 may control the travelling device 170 so that the vehicle 100 is stopped, and control the user interface 150 to output a warning message (e.g., the vehicle has stopped to avoid a collision) informing that the vehicle 100 is stopped.

When receiving a movement resumption command from the user after the vehicle 100 is stopped, the vehicle 100 may control the travelling device 170 so that the vehicle 100 resumes the movement in the reverse direction of the parking path. In this instance, the movement resumption command may be received from a smart key or a user terminal through the communicator 130, or through the inputter 120 or the user interface 150.

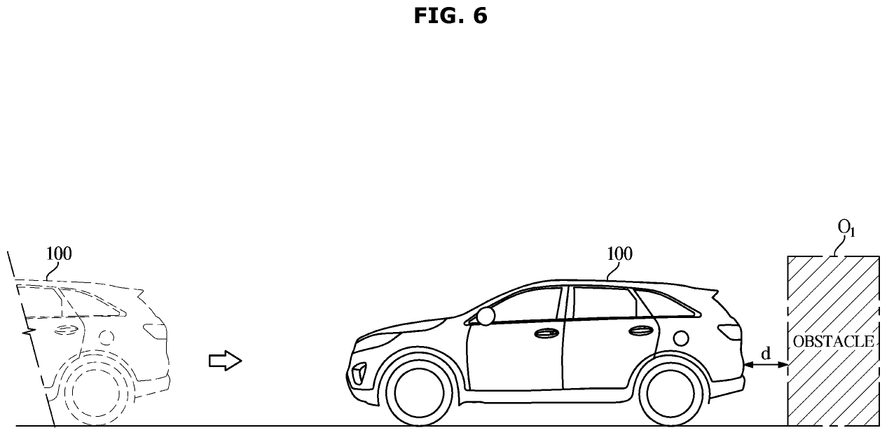

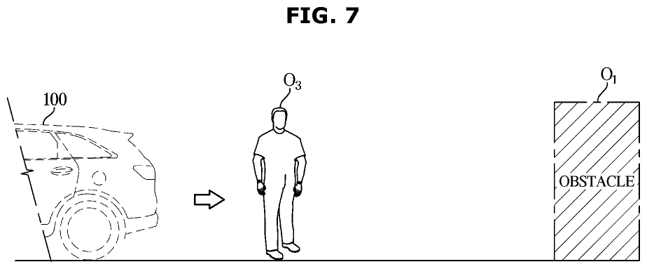

FIG. 6 is a diagram illustrating an example where the vehicle 100 receives a tailgate closing signal and returns to a parked state according to an embodiment. FIG. 7 is a diagram illustrating an example where an obstacle is located on a movement path of the vehicle 100 according to an embodiment.

Referring to FIG. 6, according to an embodiment, when receiving a closing signal for the tailgate 165 (a tailgate closing signal) after the tailgate 165 is opened, the vehicle 100 may control the travelling device 170 so that the vehicle 100 returns to a location where the vehicle 100 was parked (parking location).

In this instance, the tailgate closing signal may be received from a smart key or a smartphone through the communicator 130, or through the inputter 120.

According to embodiments, when receiving the closing signal for the tailgate 165 after the tailgate 165 is opened, the vehicle 100 may control the user interface 150 to output a message (e.g., The vehicle will move to its original position. If undesired, please press a switch to stop an operation) warning of movement of the vehicle 100.

In this instance, when a predetermined period of time (e.g., 3 seconds) elapses after the message warning of the movement of the vehicle 100 is output, the vehicle 100 may control the travelling device 170 so that the vehicle 100 starts returning to the location where the vehicle 100 was parked.

Also, when receiving a movement suspension command from a user before the predetermined period of time (e.g., 3 seconds) elapses after the message warning of the movement of the vehicle 100 is output, the vehicle 100 may be controlled not to move. In this instance, the movement suspension command may be received from a smart key or a user terminal through the communicator 130, or through the inputter 120 or the user interface 150.

Referring to FIG. 7, according to an embodiment, when identifying an obstacle O₃ located on a movement path while the vehicle 100 moves to return to the location where the vehicle 100 was parked, the vehicle 100 may control the travelling device 170 so that the vehicle 100 is stopped and control the user interface 150 to output a warning message (e.g., the vehicle has stopped to avoid a rear collision) informing that the vehicle 100 is stopped.

When receiving a movement resumption command from the user after the vehicle 100 is stopped, the vehicle 100 may control the travelling device 170 so that the vehicle 100 resumes a movement in a reverse direction of a parking path. In this instance, the movement resumption command may be received from a smart key or a user terminal through the communicator 130, or through the inputter 120 or the user interface 150.

According to embodiments, the warning message described above may be a voice message, but is not limited thereto. According to embodiments, the warning message may be an image message displayed on a display. Also, according to embodiments, the vehicle 100 may control the communicator 130 to transmit the warning message to a user terminal.

Hereinafter, control methods of the vehicle 100 according to embodiments of the disclosure are described in detail. The vehicle 100 according to the above-described embodiments may be used for the control methods of the vehicle 100. Accordingly, the above description with reference to FIGS. 1 to 7 may be equally applicable to the control methods of the vehicle 100.

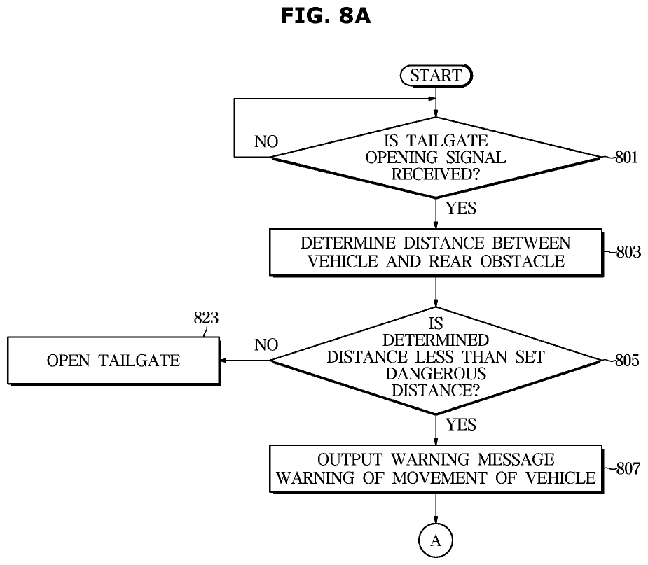

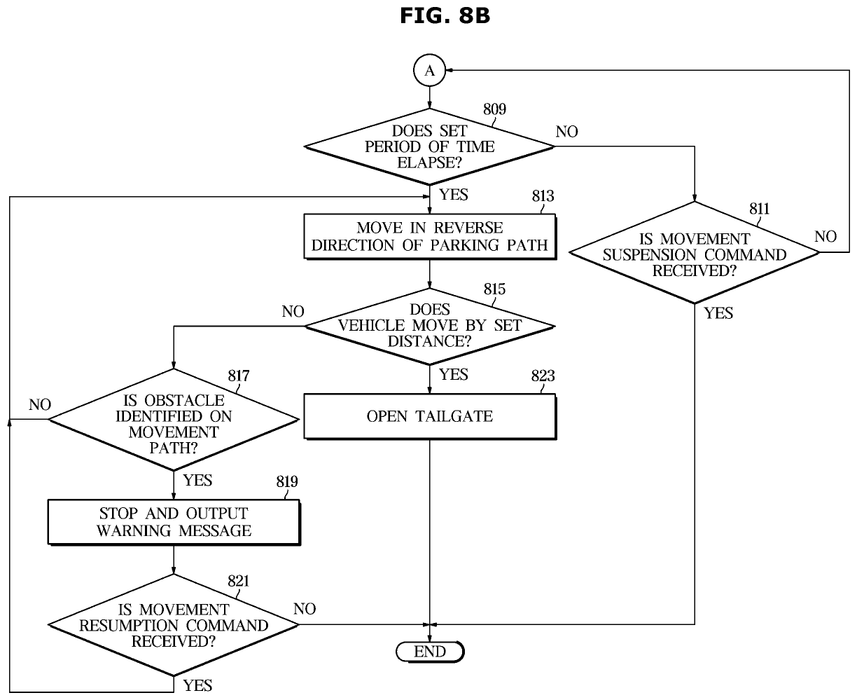

FIGS. 8A and 8B are flowcharts illustrating operations for securing a rear area when opening the tailgate 165 in a control method of the vehicle 100 according to an embodiment.

Referring to FIGS. 8A and 8B, according to an embodiment, when a tailgate opening signal is received (Yes in operation 801), the vehicle 100 may determine a distance d between the vehicle 100 and the rear obstacle O₁ (803).

According to an embodiment, when the determined distance d is greater than or equal to a set dangerous distance dᵣ (No in operation 805), the vehicle 100 may open the tailgate 165 (823).

According to an embodiment, when the determined distance d is less than the set dangerous distance dᵣ (Yes in operation 805), the vehicle 100 may output a warning message warning of a movement of the vehicle 100 (807). When a set period of time elapses (Yes in operation 809), the vehicle 100 may move in a reverse direction of a parking path (813).

However, before the set period of time elapses (No in operation 809) and when a movement suspension command is received (Yes in operation 811), the vehicle 100 may be controlled not to move.

According to an embodiment, when the vehicle wo moves by a set distance (Yes in operation 815), the vehicle 100 may open the tailgate 165 (823).

In this instance, before the vehicle 100 moves by the set distance (No in operation 815) and when an obstacle O₂ is identified on the movement path (Yes in operation 817), the vehicle 100 may stop and output a warning message (819). In this instance, when a movement resumption command is received (Yes in operation 821), the vehicle 100 may resume the movement in the reverse direction of the parking path (813).

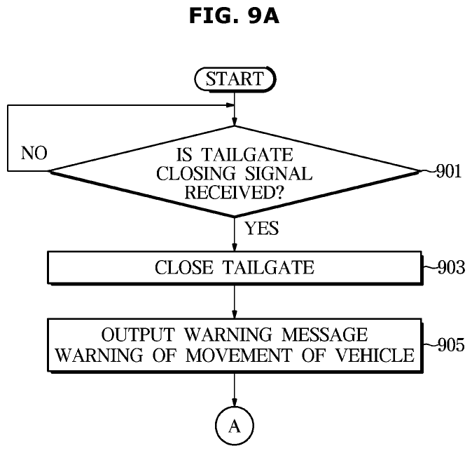

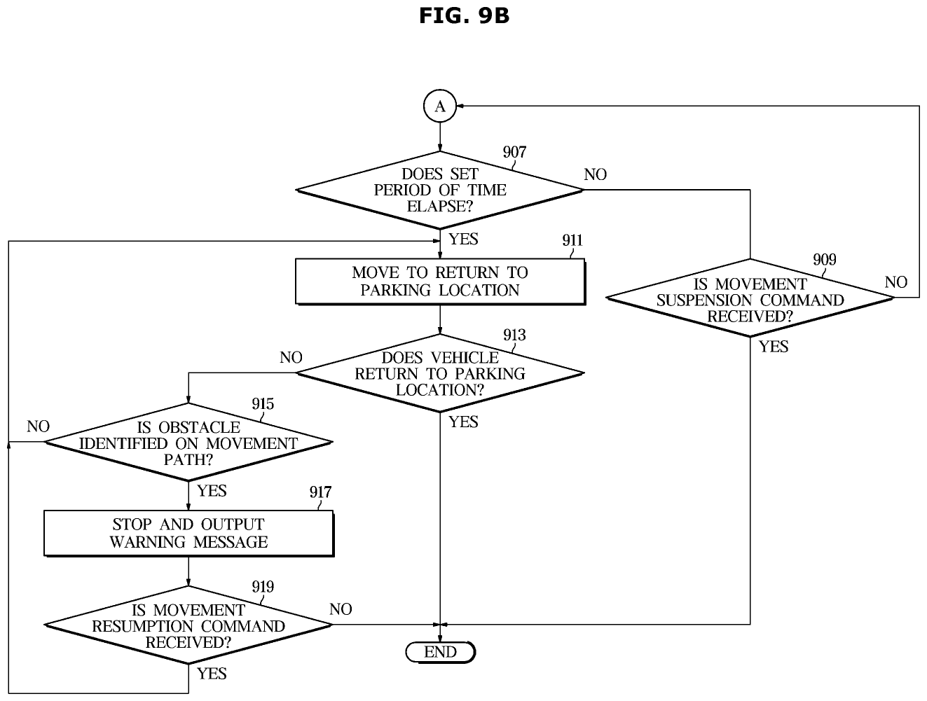

FIGS. 9A and 9B are flowcharts illustrating operations for returning to a parking location after closing a tailgate in a control method of the vehicle wo according to an embodiment.

Referring to FIGS. 9A and 9B, according to an embodiment, when a tailgate closing signal is received (Yes in operation 901), the vehicle wo may close the tailgate 165 (903) and output a warning message warning of a movement of the vehicle 100 (905).

According to an embodiment, when a set period of time elapses after the warning message is output (Yes in operation 907), the vehicle 100 may move to return to a parking location of the vehicle 100 (911).

In this instance, before the set period of time elapses after the warning message is output (No in operation 907) and when a movement suspension command is received (Yes in operation 909), the vehicle 100 may not move.

According to an embodiment, when the vehicle wo returns to the parking location of the vehicle 100 (Yes in operation 913), the vehicle 100 may end operations. In this instance, before the vehicle 100 returns to the parking location of the vehicle 100 (No in operation 913) and when an obstacle O₃ is identified on the movement path (Yes in operation 915), the vehicle wo may stop and output a warning message (917). Afterwards, when a movement resumption command is received again (Yes in operation 919), the vehicle 100 may move to return to the parking location (911).

As is apparent from the above, according to the embodiments of the disclosure, the vehicle and the control method thereof can identify a rear obstacle when a tailgate opening signal is input while parked, move the vehicle in a reverse direction of a parking path, and then open a tailgate, thereby securing a rear area of the vehicle when operating the tailgate.

Embodiments can thus be implemented through computer readable code/instructions in/on a medium, e.g., a computer readable medium, to control at least one processing element to implement any above described exemplary embodiment. The medium can correspond to any medium/media permitting the storing and/or transmission of the computer readable code.

The computer-readable code can be recorded on a medium or transmitted through the Internet. The medium may include read only memory (ROM), random access memory (RAM), magnetic tapes, magnetic disks, flash memories, and optical recording mediums.

Although embodiments have been described for illustrative purposes, those skilled in the art will appreciate that various modifications, additions and substitutions are possible, without departing from the scope and spirit of the disclosure. Therefore, embodiments have not been described for limiting purposes.

What is claimed is:

1. A vehicle comprising:
a tailgate;
a tailgate opening and closing device;
a travelling device;
an object detection sensor; and
a controller configured to:
in response to receiving an opening signal for the tailgate while the vehicle is parked, determine a distance to an obstacle located at a rear of the vehicle based on an output of the object detection sensor;
in response to the distance being greater than or equal to a predetermined dangerous distance, control the tailgate opening and closing device to open the tailgate; and
in response to the distance being less than the predetermined dangerous distance, control the travelling device to move the vehicle by a predetermined movement distance in a reverse direction of a parking path and control the tailgate opening and closing device to open the tailgate after the vehicle moves by the predetermined movement distance.

2. The vehicle of claim 1, wherein, in response to receiving a closing signal for the tailgate after the tailgate is opened, the controller is configured to control the travelling device to return the vehicle to a location where the vehicle was parked.

3. The vehicle of claim 2, further comprising a user interface.

4. The vehicle of claim 3, wherein, in response to the distance being less than the predetermined dangerous distance, the controller is configured to control the user interface to output a message warning of an intended movement of the vehicle.

5. The vehicle of claim 4, wherein the controller is configured to:
control the travelling device to start moving the vehicle in the reverse direction of the parking path after a predetermined period of time elapses after the message warning of the intended movement of the vehicle is output and no movement suspension command has been received from a user; and
control the vehicle not to move, in response to receiving a movement suspension command from the user before the predetermined period of time elapses after the message warning of the intended movement of the vehicle is output.

6. The vehicle of claim 3, wherein, in response to identifying an additional obstacle located on a movement path while the vehicle moves in the reverse direction of the parking path, the controller is configured to control the travelling device to stop the vehicle and control the user interface to output a warning message informing that the vehicle is stopped.

7. The vehicle of claim 6, wherein the controller is configured to control the travelling device to resume movement of the vehicle in the reverse direction of the parking path, in response to receiving a movement resumption command from a user after the vehicle is stopped.

8. The vehicle of claim 3, wherein the controller is configured to control the user interface to output a message warning of an intended movement of the vehicle, in response to receiving the closing signal for the tailgate after the tailgate is opened.

9. The vehicle of claim 8, wherein the controller is configured to:
control the travelling device to start returning the vehicle to the location where the vehicle was parked after a predetermined period of time elapses after the message warning of the intended movement of the vehicle is output and no movement suspension command has been received from a user; and
control the vehicle not to move in response to receiving a movement suspension command from the user before the predetermined period of time elapses after the message warning of the intended movement of the vehicle is output.

10. The vehicle of claim 3, wherein, in response to identifying an additional obstacle located on a movement path while the vehicle moves to return to the location where the vehicle was parked, the controller is configured to control the travelling device to stop the vehicle and control the user interface to output a warning message informing that the vehicle is stopped.

11. The vehicle of claim 10, wherein the controller is configured to control the travelling device to resume moving the vehicle to return to the location where the vehicle was parked, in response to receiving a movement resumption command from a user after the vehicle is stopped.

12. A method of controlling a vehicle comprising a tailgate the control method comprising:
receiving an opening signal for the tailgate while the vehicle is parked;
sensing a distance to an obstacle located at a rear of the vehicle; and
when the distance is greater than or equal to a predetermined dangerous distance, controlling opening the tailgate; and
when the distance is less than the predetermined dangerous distance, causing the vehicle to move by a predetermined movement distance in a reverse direction of a parking path and causing the tailgate to open after the vehicle moves by the predetermined movement distance.

13. The method of claim 12, wherein the vehicle further comprises an opening and closing device configured to open or close the tailgate, a travelling device configured to move the vehicle, an object detection sensor configured to detect an object around the vehicle, and a user interface.

14. The method of claim 12, further comprising, after the tailgate is opened, causing the vehicle to return to a location where the vehicle was parked after a closing signal for the tailgate is received.

15. The method of claim 12, wherein causing the vehicle to move by the predetermined movement distance in the reverse direction of the parking path comprises outputting a message warning of an intended movement of the vehicle.

16. The method of claim 15, wherein causing the vehicle to move by the predetermined movement distance in the reverse direction of the parking path comprises causing the vehicle to start moving in the reverse direction of the parking path when a predetermined period of time elapses after the message warning of the intended movement of the vehicle is output and no movement suspension command is received from a user before the predetermined period of time elapses.

17. The method of claim 12, wherein an additional obstacle located on a movement path is identified while the vehicle moves in the reverse direction of the parking path, the method further comprising causing the vehicle to move by the predetermined movement distance in the reverse direction of the parking path comprises causing the vehicle to stop and outputting a warning message informing that the vehicle has stopped.

18. The method of claim 17, wherein causing the vehicle to move by the predetermined movement distance in the reverse direction of the parking path comprises causing the vehicle to resume moving in the reverse direction of the parking path when a movement resumption command is received from a user after the vehicle is stopped.

19. The method of claim 13, wherein causing the vehicle to return to the location where the vehicle was parked comprises outputting a message warning of an intended movement of the vehicle.

20. The method of claim 19, wherein causing the vehicle to return to the location where the vehicle was parked comprises causing the vehicle to start returning to the location where the vehicle was parked when a predetermined period of time elapses after the message warning of the intended movement of the vehicle is output and a movement suspension command is not received from a user before the predetermined period of time elapses.
